(19) United States
(12) Patent Application Publication
(10) Pub. No.: US 2003/0149830 A1
(43) Pub. Date: Aug. 7, 2003

(54) Interface technology for moving data via a third party copy engine

(76) Inventors: Terry Alan Torr, Auburn, CA (US); David E. Oseto, Newcastle, CA (US)

Correspondence Address: HEWLETT-PACKARD COMPANY, Intellectual Property Administration, P.O. Box 272400, Fort Collins, CO, 80527-2400, US

(21) Appl. No.: 10/034,415

(22) Filed: Dec. 28, 2001

(51) Int. Cl. G06F 12/00; G06F 12/14; G06F 12/16; G06F 13/00; G06F 13/28; G06F 9/00; G06F 9/46

(52) U.S. Cl. 711/100; 709/219

(57) ABSTRACT

An interface technology is disclosed by which an application program running on a host can invoke a command to cause a third party copy engine (“3PCE”) to carry out a desired copy operation without actually generating the command needed by the 3PCE. A first code arrangement is provided, receipt of which causes a processor to generate a second code arrangement representing a third party copy command and its corresponding parameters. Also, a liaison system and method are provided. The liaison system is interposed between an application program running on a host and a 3PCE external to the host. Such a liaison system comprises: an application program interface (“API”) to receive the first code arrangement (mentioned above); and a copy command generator to generate the second code arrangement representing the third party copy command and its corresponding parameters.

### FIELD OF THE INVENTION

The invention is generally directed to the field of data backup, and more particularly to a technology by which a host computer is unloaded from having to carry out a copy operation of data from an external source to an external destination via a third party copy engine (“3PCE”), and more particularly to an interface technology by which an application program running on a host can cause a 3PCE to carry out the desired copy operation.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

The need to preserve data integrity requires that a primary storage location for data be backed-up, i.e., that a copy of the data on the primary storage location be made and kept at least one secondary storage location. Where the primary storage location is a non-volatile storage device used by a server connected to a network, the server must copy the data from its non-volatile storage device to a secondary back-up device. Given the great volume of data processed and generated each day in the present computing environment, a copy operation to backup data can significantly diminish the bandwidth of a server that is otherwise available to a client.

To combat this problem, the American National Standards Institute (ANSI) modified the small computer system interface (SCSI) standard to include an EXTENDED COPY command within its command set (see, e.g., SCSI version T10/99-143rl or T10/1236-D revision 18). The EXTENDED COPY command unloads a server from having to carry out the actual read and write operations associated with backing up data by moving that burden to a third party copy engine (“3PCE”). This is shown in more detail via the depiction of system 100 in FIG. 1.

In FIG. 1, a host/server 102 is shown as currently running three processes corresponding to application programs 104, 106 and 108. Such application programs can be data backup programs such as the OPENVIEW OMNIBACK II brand of backup program available from the HEWLETT-PACKARD COMPANY, the NETBACKUP BUSINESS SERVER brand of backup and recovery software available from the VERITAS SOFTWARE COMPANY and the NETWORKER brand of backup available from LEGATO SYSTEMS INC. Any such application program, 104, 106, 108 can free the host 102 from having to carry out the actual reads and writes associated with a backup process by using the SCSI EXTENDED COPY command.

The EXTENDED COPY command is sent to a 3PCE 112 directly or via a packet transformer 110 such as a FIBRE CHANNEL switch (which is shown as a dashed box in FIG. 1 because it is optional). An optional part of the communication path between the packet transformer 110 and the application programs 104, 106 and 108 can be the internet 120 (accordingly shown as a dashed cloud in FIG. 1). The 3PCE 112 responds to the EXTENDED COPY command by transferring data from one or more source devices to one or more target devices.

In FIG. 1, the storage devices are shown as two RAID (redundant array of independent disks) device 114 and 116 as well as a tape drive 118, for example. The RAID device 114, 116 and the tape drive 118 are each shown as communicating with the 3PCE 112 optionally through the internet 120 as well as through an optional storage area network (SAN) 124. Alternatively, one or more of the RAID device 114, 116 and the tape drive 118 could be directly connected to the third party copy engine 112. Typically, the third party copy engine 112 will either be external to the storage devices, e.g., the INTELLIGENT STORAGE ROUTER brand of router available from CHAPARRAL NETWORK STORAGE, Inc., or internal to the storage device itself, e.g., the SURESTORE brand of RAID available from the HEWLETT-PACKARD COMPANY.

### SUMMARY OF THE INVENTION

The invention, in part, provides an interface technology by which an application program running on a host can invoke a command to cause a 3PCE to carry out a desired copy operation without actually generating the command needed by the 3PCE.

The invention also is, in part, directed to a first code arrangement on a computer-readable medium, execution of which causes a processor to generate a second code arrangement representing a third party copy command and its corresponding parameters. Such a first code arrangement comprises: a calling portion in response to which said processor is operable to begin said generation process; and at least one data entity portion upon which said generation process operates. Each data entity portion identifies a third party copy device (“3PCE”) to carry out the copy process, a destination device to receive the copied data, desired data that is to be copied and a source of said desired data.

The invention also is, in part, directed to a liaison system interposed between an application program running on a host and a third party copy engine (3PCE) external to said host, said application program needing to copy desired data from a source device external to said host to a destination device external to said host via said 3PCE. Such a liaison system comprises: an application program interface (API) to receive the following first code arrangement from said application program, namely a calling portion, and at least one data entity portion that identifies said 3PCE, said destination, said desired data and said source; and a copy command generator to generate a second code arrangement representing a third copy command and corresponding parameters thereof that will cause said 3PCE to copy said desired data from said source to said destination; wherein said generator begins operation in response to said calling portion; and wherein said generator is operable to generate said second code arrangement based upon said data entity portion.

The invention also, in part, is directed toward a method of interfacing between application program running on a host and a third party copy engine (3PCE) external to said host, said application program needing to copy desired data from a source device external to said host to a destination device external to said host via said 3PCE. Such a method comprises: receiving a first code arrangement from said application program, said first code arrangement including a calling portion and at least one data entity portion that identifies said 3PCE, said destination, said desired data and said source; initiating, in response to said calling portion segment, a process to generate a second code arrangement representing a third party copy command and corresponding parameters thereof that will cause said 3PCE to copy said desired data from said source to said destination; and forming, once said process is begun, said second code arrangement based upon said data entity portion.

The invention also, in part, is directed toward a computer-readable medium having code portions embodied thereon that, when read by a first processor, cause a second processor to perform such a method.

Additional features and advantages of the invention will be more fully apparent from the following detailed description of the preferred embodiments, the appended claims and the accompanying drawings.

### BRIEF DESCRIPTION OF THE DRAWINGS

The accompanying drawings are: intended to depict example embodiments of the invention and should not be interpreted to limit the scope thereof; and not to be considered as drawn to scale unless explicitly noted.

FIG. 1 is a block diagram depiction of a third party copy engine (3PCE) architecture according to the background art;

FIG. 2 is a depiction of a 3PCE architecture according to an embodiment of the invention;

FIG. 3 is a block diagram of some of the components within a server;

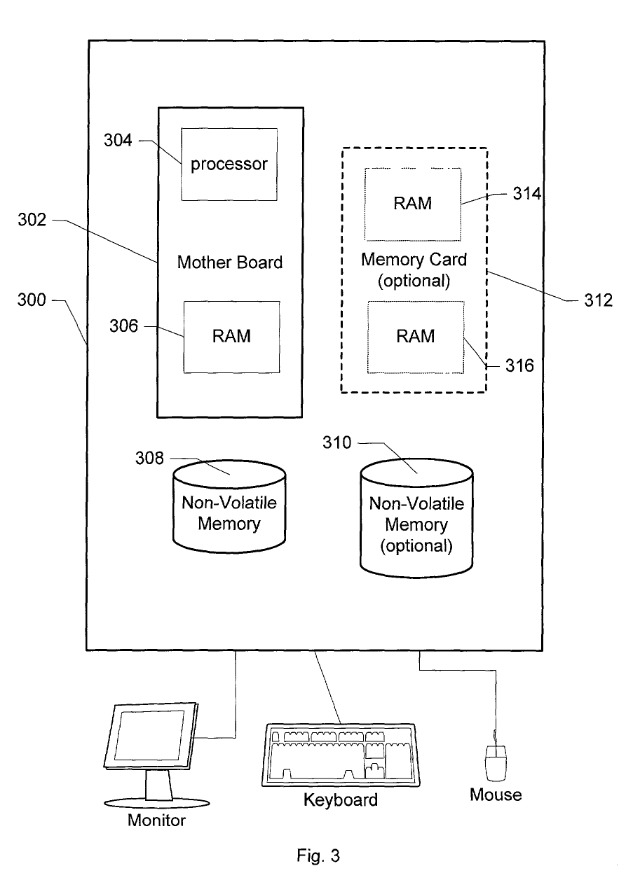

FIG. 4 is a second embodiment of a 3PCE architecture according to the invention;

FIG. 5 is a version of FIG. 4 that is more detailed in some respects as well as more simplified in some respects;

FIG. 6 is a flowchart of process steps carried out by an application program that makes use of the liaison according to an embodiment of the invention; and

FIG. 7 is a flowchart depicting process steps carried out by the liaison according to an embodiment of the invention.

### DETAILED DESCRIPTION OF THE PREFERRED EMBODIMENTS

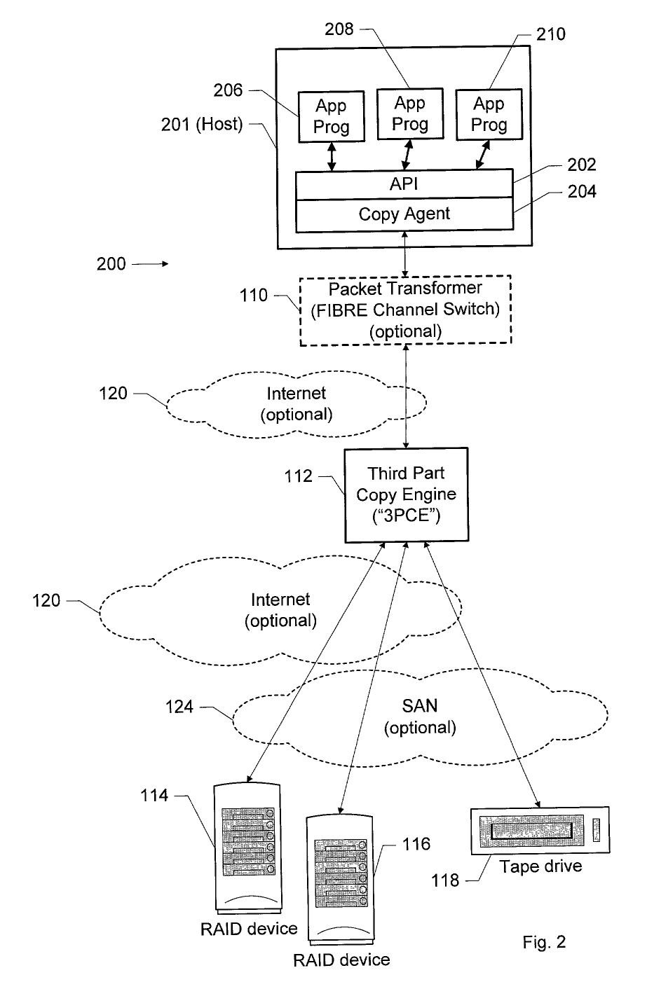

FIG. 2 is a depiction of a 3PCE architecture according to an embodiment of the invention. The system 200 of FIG. 2 includes a host/server 201 that is running application programs 206, 208 and 210. These programs correspond to programs 104, 106 and 108 of the background art except for their use of the copy agent (or liaison) 204 according to an embodiment of the invention as well as the application program interface (API) 202 (according to an embodiment of the invention). The third party copy engine (“3PCE”) architecture of FIG. 2 shows the 3PCE 112 as being physically distinct from the data storage devices 114, 116 and 118. The host 201 is shown as connecting to the 3PCE 112 through an optional packet transformer 110 (such as a FIBRE CHANNEL SWITCH) and also optionally through the internet 120.

The FIBRE CHANNEL switch 110 encapsulates SCSI commands in a protocol that can be sent over much longer distances. An example of an external 3PCE 112 is the INTELLIGENT STORAGE ROUTER brand of router available from CHAPARRAL NETWORK STORAGE, Inc., mentioned above. Alternatively, a different packet transformer 110 could be used, such as one that transforms into the ISCSI protocol (also known as SCSI/IP). Regardless, nothing about the invention is limited to the FIBRE CHANNEL environment.

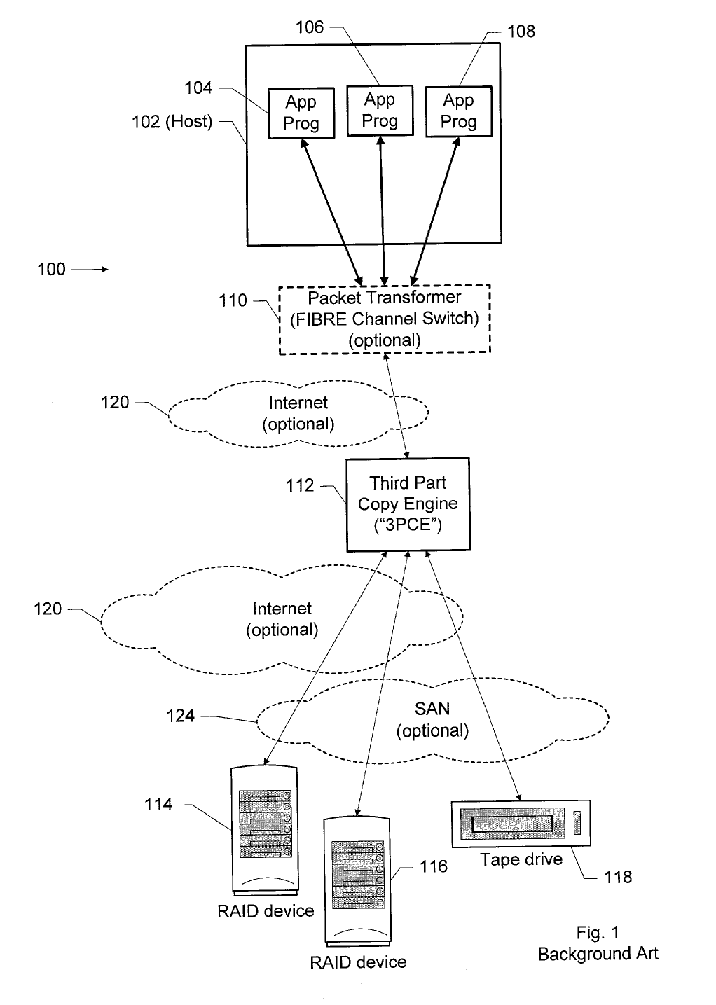

The 3PCE 112 is shown as communicating with each of the storage devices 114, 116 and 118 optionally through the internet 120 as well as a storage area network (SAN) 124. As with the background art FIG. 1, optional components are illustrated in dashed lines.

Three application programs 206, 208 and 210 have been depicted in FIG. 2 for illustration purposes. The appropriate number of application programs will vary depending upon the circumstances of the server. Similarly, FIG. 2 depicts the storage devices as two RAID (redundant array of independent disks) devices 114, 116 and a tape drive 118. The actual storage devices used will depend upon the circumstances to which the copy command is applied.

In contrast, the 3PCE 112 of FIG. 2 is external to each of the backup storage devices 114, 116 and 118. The 3PCE 404 communicates with the other storage devices 116 and 118 through the optional SAN 124. An example of such a RAID device 402 is the type of RAID device made available by the HEWLETT-PACKARD COMPANY, mentioned above.

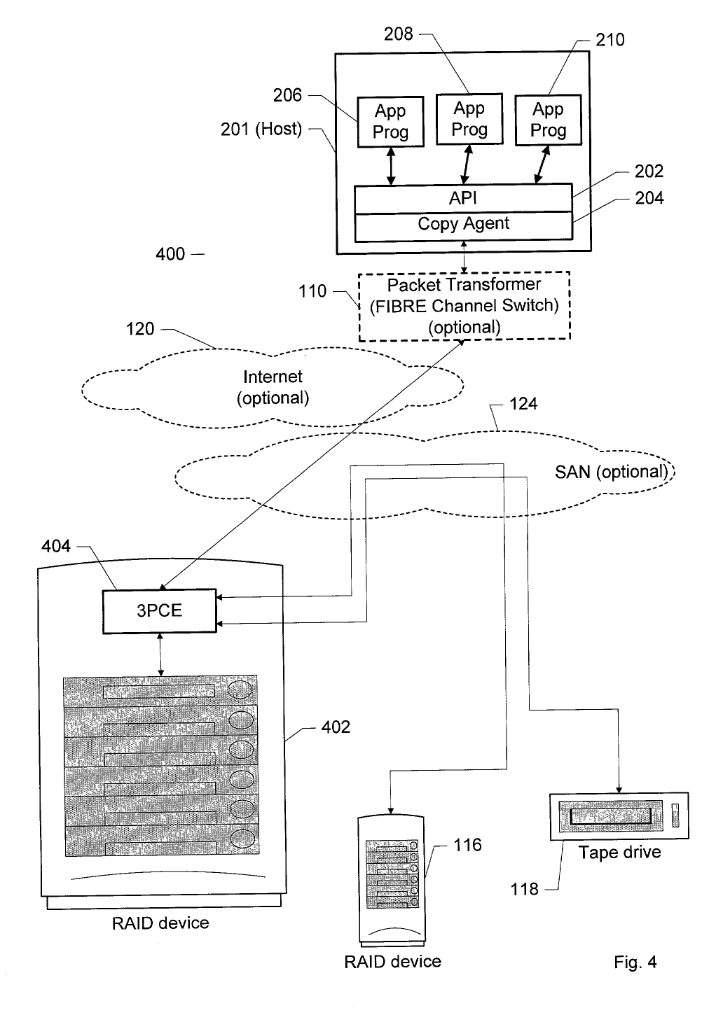

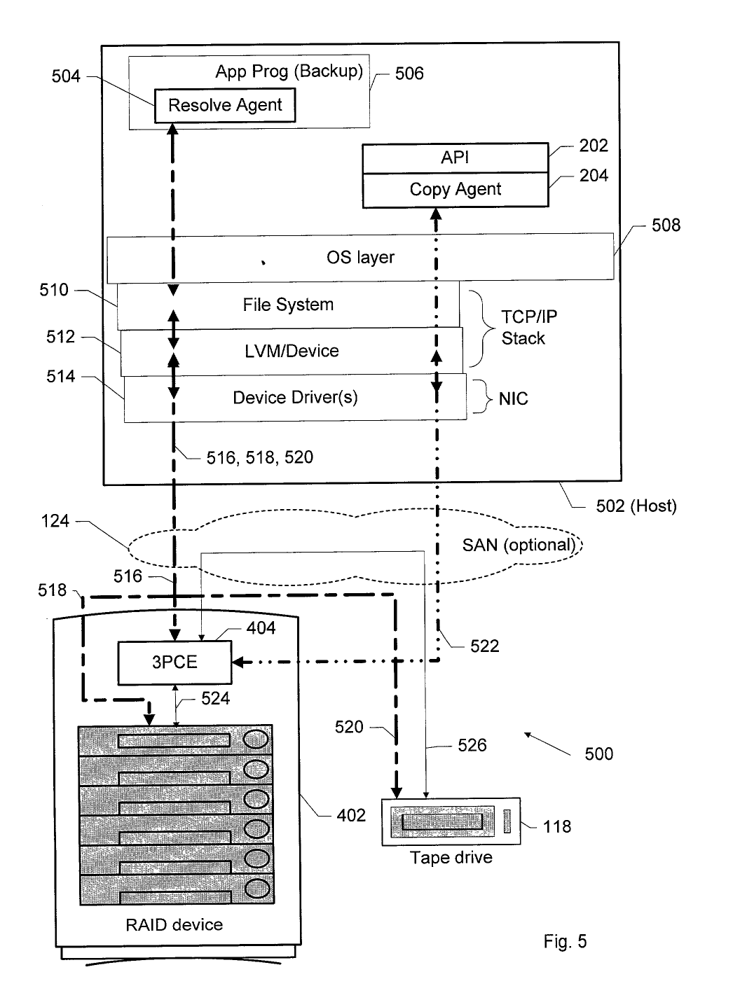

FIG. 5 is a version of FIG. 4 that is more detailed in some respects as well as more simplified in some respects (e.g., the packet transformer 110, the internet 120 and the tape drive 118 are not shown). The architecture 500 depicts an application program 50 that includes a resolve agent 504. The application program 506 is similar to any one of the application programs 206, 208 or 210, except that the resolve agent 504 is depicted as a discrete component, whereas it is considered integral (to the extent that it is present) in the application programs 206, 208, and 210. In addition, the host/server 502 includes an operating system (OS) layer 508, a file system 510 and LVM/device 512 that together correspond to the TCP/IP stack, and one or more device drivers 514 that together correspond to the network interface capability.

In FIG. 5, the resolve agent 504 communicates with each of the storage devices 402 and 118 as well as the 3PCE 404 directly via the communication paths 518, 520 and 516, respectively. However, each of those communication paths travel through the file system 510, the LVM/device 512 and the device driver(s) 514. The copy agent 204 is depicted as communicating directly with the 3PCE 404 via communication path 522. However, that communication between the copy agent 204 and the 3PCE 404 goes through the device driver(s) 514. Again, desired data on the RAID array 402 is moved to the tape drive 118 via the 3PCE 404 without the desired data passing through the host 502, as indicated by the paths 524 and 526.

The operation of the liaison or copy agent 204 according to an embodiment of the invention will now be explained. Any one of the application programs 206, 208 and 210 can call the copy agent 204 by using an appropriate request (also referred to as a first code arrangement) that conforms to the protocol of the API 202. An example of such a protocol follows. The first code arrangement can take the form of source code, or machine-executable code, etc. The copy agent 204 generates one or more instances of a second code arrangement representing the actual third party copy command and its associated parameters in response to one request (or first code arrangement) from an application program 206/208/210.

This example has been written in the C language, but other high level languages could be used. The example is intended to run under the HPUX 11.0 brand of UNIX OPERATING SYSTEM made available by the HEWLETT-PACKARD COMPANY. Though couched in terms of the HPUX 11.0 Operating System, the example can be adapted to other operating systems such as WINDOWS, or LINUX or other versions of UNIX,. The copy agent 202 runs at the application level.

The example is couched at the source code level, so that the first code arrangement can take the form of the following alphanumeric string:

int gen_ex_copy(data_entity_t de[ ], int de_ent, u_char ILD[ ], int ILD_ent, u_char rcr[ ])

Here, the calling portion of the code arrangement is “gen_ex_copy” and the data entity portion, or inputs to the copy agent 202, are the parameters within the parentheses. At the machine-executable code level, the calling portion and the data entity portion are read from memory into register space of a processor in the server, i.e., are “received” by the processor, and then the processor links to the machine-executable code representing the copy agent.

The input de[ ] is an array of “data entities”. Each element of the array describes the data to be moved, the associated source(s), destination, and 3^{rd} party copy device. The input de[ ] is defined below as a “data_entity_t” type of data structure. The definition of the data_entity_t data structure itself includes the definitions of three other data structures, the “dev_desc” type, the “data_src_t” type and the “data_desc_t” type.

The input de_ent is the number of valid “de” array entries.

The input ILD[ ] is a character array of inline data to be included in the “data to be moved”. Inline data is provided for the purposes of annotating the data that is to be backed-up. This enhances data recovery because the inline data provides context for the restoration.

The input ILD_ent is the number of valid ILD array entries.

The input rcr[ ] is an array used to provide Receive Copy Results (another SCSI command) data to the calling program (e.g., 206) in the event of an unsuccessful completion. The first two bytes should contain the length of the array so that the gen_ex_copy function knows the limit of the Receive Copy Results data to be included in the array as output.

A single “data entity” might result in the generation of multiple EXTENDED COPY commands in the situation in which the amount of data to be copied is more than the 3PCE can accommodate in one copy operation. This can be necessary because operational parameters of the 3PCE limit the amount of data which can be processed in a single EXTENDED COPY command.

The structure of the data entity, mentioned above, and its subordinate structures will now be explained.

The data_entity_t type of data structure is defined as follows.

typedef struct data_entity
{

| char | dev_fn[80]; | // 3rd Party Copy Engine Descriptor |
|---|---|---|
| | | // This is a character string used to |
| | | // Open and Reference the 3^{rd} Party |
| | | // Copy Device |
| dev_desc_tdes_dev; | | // Description of the Destination Device |
| int | nae; | // # of Entries in the following |
| | | data_src_t array |
| | | // Currently a Maximum of 20 is |
| | | // supported |

| | |
|---|---|
| data_src_t ts[MAX_TS]; | // Description of Source Devices and |
| | // Data to Move. This is referred to as |
| | // the Target-Segment Array |

} data_entity_t;

The dev_desc_t type of data structure, which is used above by the data_entity_t data structure, describes the destination device. It is defined as follows.

typedef struct dev_desc
{

| | | |
|---|---|---|
| | | // |
| u_char | d_wwn[8]; | // Device WWN |
| u_char | d_lun[8]; | // Device LUN |
| u_char | d_nport[3]; | // Device N-Port |
| u_long | d_bl; | // Device Block Length |
| u_char | d_tid | // SCSI Target Identifier |
| | | (Descriptor Type E3) |
| u_char | d_type; | // Peripheral Device Type (See SCSI Spec) |
| u_int | d_flags; | // Control Flags, See Description Below |
| | | // Bit 31 Source Device Description |
| | | // Bit 30 Destination Device Description |
| | | // Bit 29 In-Line Device Description |
| | | // Bit 28 Reserved |
| | | // Bit 27 PAD Bit |
| | | // Bit 26 Reserved |
| | | // Bit 25 WWN Field Valid |
| | | // Bit 24 LUN Field Valid |
| | | // Bit 23 N-Port Field Valid |
| | | // Bit 22 Target-ID Field Valid |
| | | // Bit 21 Reserved |
| | | // Bit 20 Fixed Bit |
| | | // Bit 19 - Bit 00 - Reserved |

} dev_desc_t;

The data_src_t type of data structure, which is used above by the data_entity_t data structure, describes the source device(s). It is defined as follows.

typedef struct data_src
{

| | | |
|---|---|---|
| dev_desc_t | src_device; | // Description of a Source |
| | | Device |
| u_int | n_a_e; | // Number of Array Entries |
| data_desc_t | d2m[MAX_D2M]; | |

} data_src_t;

The data_src_t type of data structure, which is used above by the data src_t data structure, describes the data to be copied. It is defined as follows.

typedef struct data_desc
{

| | | |
|---|---|---|
| u_char | sdlba[8]; | // Logical Block Address of the Data to Move |
| | | // For ILD this is the index into the ILD |
| char | ddlba[8] | // Logical Block Addr to Place Blk to Blk |
| | | // Data Moved |
| int | sdlt; | // Stream Device Transfer Length |
| u_char | nblks[8]; | // Num of Logical Blocks to Move |
| | | // For ILD this is the number of bytes to |
| | | // Move |
| int | flags; | // Control Flags, See Description Below |
| | | // Bit 31 - Bit 01 - Reserved |
| | | // Bit 00 CAT Bit |

} data_desc_t;

The reserved bits listed in the dev_desc_t type of data structure and the data_src_t type of data structure do not always have to be reserved. Rather they can be assigned as circumstances dictate, e.g., for extensibility.

This function, i.e., the copy agent 202, returns an integer. A zero return indicates successful completion of the data move. Below are the failure code listings. This list is not exhaustive, for simplicity. Only the low order 3 bytes are relevant. If there are bits set in the upper byte, they should be ignored.

| | | |
|---|---|---|
| // | 0x00000000 | Successful Return |
| // | | |
| // | 0x00000001 | Error during Inquiry Request to 3^{rd} Party Copy Device |
| // | | |
| // | 0x00000002 | Non Supported 3^{rd} Party Copy Device |
| // | | |
| // | 0x00000003 | Number of “Data Entities” <= 0 |
| // | | |
| // | 0x00000004 | Number of InLine Data Bytes < 0 |
| // | | |
| // | 0x00000005 | Open Error for 3^{rd} Party Copy Device |
| // | | |
| // | 0x00000006 | SCSI Command Error |
| // | | |
| // | 0x00000007 | Parameter Length List Error |
| // | | |
| // | 0x00000009 | Destination Device Not a Stream Device |
| // | | |
| // | 0x0000000a | In Line Data Segment Not Supported |
| // | | |
| // | 0x0000000b | Embedded InLine Data Exceeds Limit |
| // | | |
| // | 0x00001000 | Operational Parameter Error |
| // | | |
| // | 0x00001002 | Target Descriptor Build Error |

In the example above, each element in the data_entity_t array will cause one or more SCSI EXTENDED COPY commands to be generated. Also, each element within the array data_entity_t can specify only one destination device and only one 3PCE. One of ordinary skill in the art will recognize that this data structure permits different elements in the array to specify different destination devices and/or 3PCEs.

Despite having limited each SCSI EXTENDED COPY command to only one destination, multiple SCSI EXTENDED COPY commands can be requested by an application program so as to, in effect, copy data to multiple destinations.

The example of the copy agent 204 given above, namely the function “gen_ex_copy” will support version T10/99-143rl or T10/1236-D revision 18) of the EXTENDED COPY command. However, one of ordinary skill in the art would understand that the disclosed example can be readily modified to support other versions.

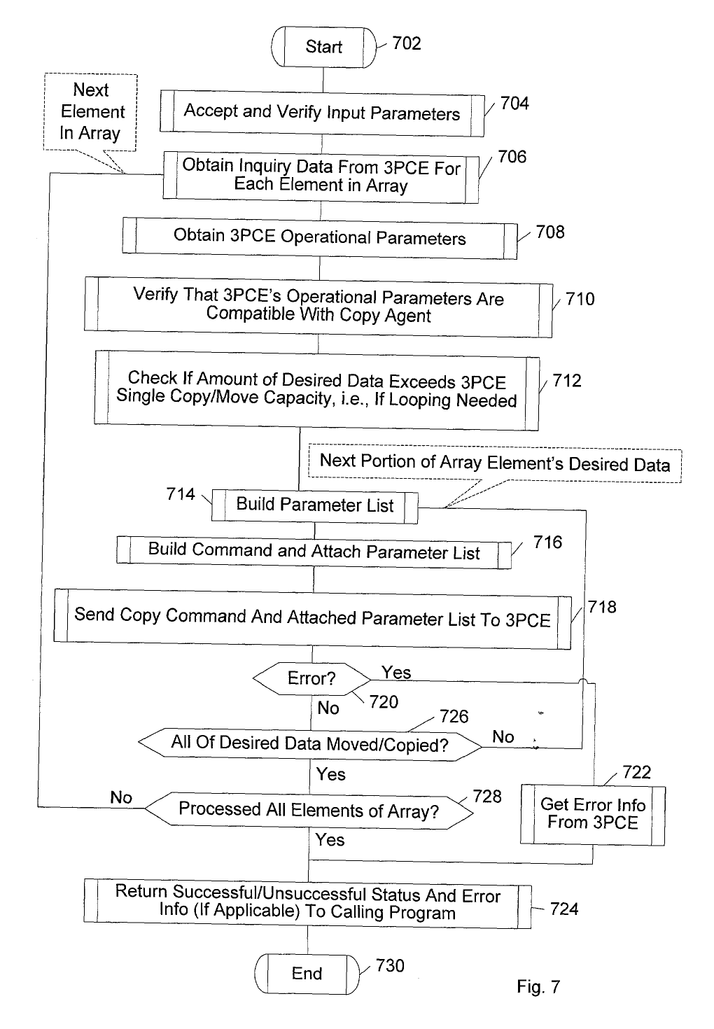

The function or copy agent 202, again, is executed by the server 201. The steps performed by the copy agent are depicted in FIG. 7.

In FIG. 7, flow starts at step 702 and progresses to step 704, where the copy agent 204 accepts and verifies the input parameters that were received via the API 202 from the application program, e.g., 206, for each element in the data element array, e.g., de[ ] in the example above. Again, those input parameters correspond to an identification of the 3PCE that is to carry out the copy process, an identification of a destination device to receive the copied data, an identification of the desired data itself that is to be copied and an identification of one or more source devices having the desired data.

At step 706, the copy agent 204 obtains inquiry data from the 3PCE 112/404, via the SCSI command, INQUIRY, in order to check if the copy agent 204 supports the 3PCE 112/404. Step 706 is provided to avoid the situation in which the EXTENDED COPY command is generated only to find that the 3PCE 112/404 is not supported, thus wasting computational resources of the server 201. If it is discovered at step 706 that the 3PCE 112/404 is not supported, the copy agent 204 will terminate and return an error.

At step 708, the copy agent 204 obtains the operational parameters supported by the 3PCE. These are the limitations of the 3PCE 112/404 that must be adhered to in order to generate a valid EXTENDED COPY command (and associated parameter list). At step 710, the copy agent 204 verifies that it can generate an EXTENDED COPY command that will adhere to all of the operational parameters required by the 3PCE 112/404. If not, then the copy agent 204 will terminate and return an error. For example, it might not be necessary for the copy agent 204 to use all of the operational parameters to generate an EXTENDED COPY command. So the copy agent 204 will verify that the 3PCE 112/404 can tolerate receipt of fewer than all of its operational parameters.

At step 712, the copy agent 204 checks if the amount of desired data specified by the element of the data entity array, e.g., de[ ], exceeds the single copy/move capacity of the 3PCE 112/404. If so, multiple EXTENDED COPY commands will have to be generated to move the total amount of desired data.

At step 714, the copy agent 204 builds the list of parameters for the EXTENDED COPY command. The command parameter list that is generated by the copy agent at step 714 includes target descriptors, segment descriptors, in-line data and control information. Target descriptors and segment descriptors are described in the SCSI specification, an example of which is provided above. There are a number of different target descriptors and segment descriptors. The type of descriptors which are built by the copy agent according to an embodiment of the invention will depend on the descriptors supported by the 3PCE and the information input by the application program 506. If a descriptor cannot be built due to insufficient information or inadequate descriptor support, the copy agent will exit with an error.

At step 716, the copy agent 204 builds the EXTENDED COPY command code and attaches the parameters list built in preceding step 714. At step 718, the copy agent 204 sends the copy command and the attached parameter list to the 3PCE 112/404.

At step 720, the copy agent 204 determines whether there has been an error reported by the 3PCE 112/404. If so, at step 722, the copy agent 204 sends the SCSI command, RECEIVE COPY RESULTS, to the 3PCE 112/404. Then flow proceeds to step 724, where the copy agent 204 informs the application 206 program (i.e.. the program that called it) of the unsuccessful status and provides the Error Info produced by the RECEIVE COPY RESULTS command. The flow proceeds to step 730 where flow ends.

If no error is found at step 720, then flow proceeds to step 726. At step 726, the copy agent 204 determines if all of the desired data specified by the currently considered element of the data entity array, e.g., de[ ], has been copied/moved.

If not, flow loops back up to step 714. But if so, flow proceeds to step 728, where the copy agent 204 determines whether all elements in the data entity array, e.g., de[ ], have been processed. If not, flow loops back up to step 706 to process the next element. But if so, flow proceeds to step 726, where the copy agent 204 informs the application program 206 of a successful status. No error information is provided in this situation because no error condition arose. And then flow ends at step 726.

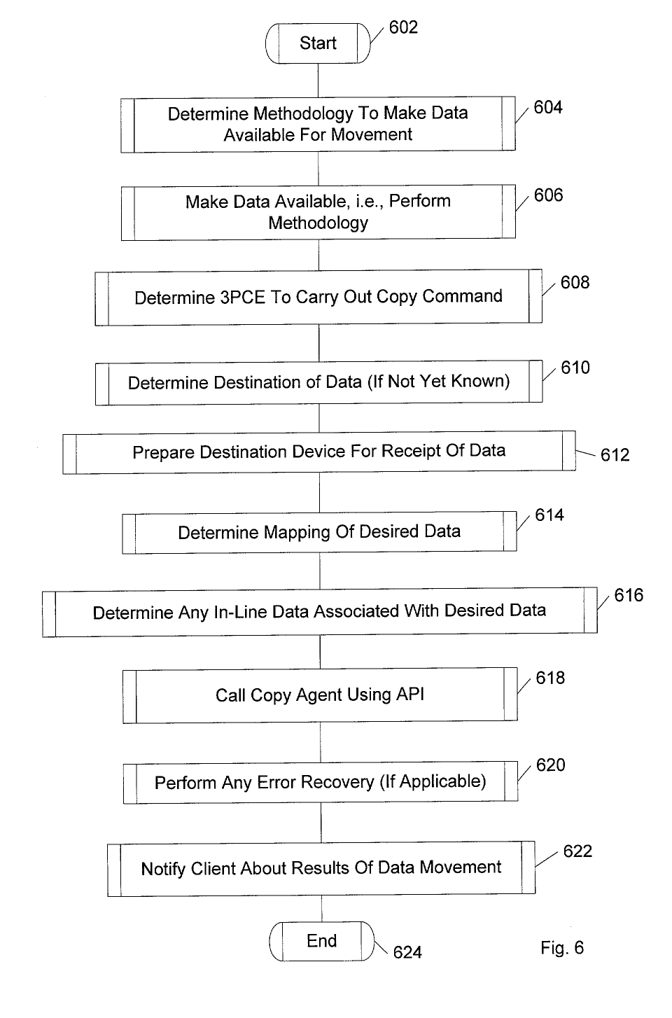

How an application program, e.g., 206, makes use of the API 202 and the copy agent 204 is put into context by the flowchart of FIG. 6. The process starts at step 602 and proceeds to step 604 where the application program, e.g., 506, determines what methodology is to be used in order to make the data available for movement. Such methodologies can include the split methodology, the mirror methodology, the snapshot methodology, etc. At step 606, the application program 506 makes the data available. In other words, it performs the selected methodology.

At step 608, the application program 506 determines which 3PCE will carry out the copy command. This may include the application program 506 retrieving some or all of the parameters and limitations of the selected 3PCE.

At step 610, the application program 506 determines the destination of the data to be copied. In some instances, this has already been determined by the client of the application program 506.

At step 612, the application program 506 prepares the destination device for the receipt of the desired data. This can include, in the case of a tape drive, repositioning the tape and/or mounting different tapes. At step 614, the resolve agent 504 within the application program 506 determines the mapping (i.e., location) of the desired data. This deals with the possibility that the desired data can be broken up and stored in multiple physical locations/drives and yet considered, at a logical level, to be one unit.

At step 616, the application program 506 determines any in-line data that is associated with the desired data. Then at step 618, the application program 506 calls the copy agent 204 via use of the API 202. Again, the application program 506 executes a function corresponding to the copy agent 506 and passes parameters to the copy agent 506. The parameters identify the 3PCE (by whom the copy process is to be administered), the data source device(s) (from whom the desired data is to be copied), the desired data that is to be copied, the destination device (to whom the data is to be copied), the rcr[ ] array (to be filled by the copy agent 204) and (optionally) any in-line data.

After the copy agent 204 returns its status information and results, the application program 506 can perform error recovery at step 620, if that is appropriate. At step 622, the application program 506 notifies its client about the results of the data movement. At step 624, the process ends.

The communications being performed by the resolve agent 504 at step 614 are depicted in FIG. 5 as communication paths 516, 518 and 520. Again, the communications by the copy agent at step 618 are depicted in FIG. 5 as the communication path 522.

The example of the copy agent given above generates an EXTENDED COPY command according to the SCSI standard. However, the invention is not to be limited to only the SCSI EXTENDED COPY command. Rather, the invention has applicability to other types of data copy and data movement commands that involve the use of a third party copy engine, source devices and destination devices.

Similarly, use of the API and copy agent according to an embodiment of the invention has been couched in terms of servicing a backup program. But the invention has wider usefulness, namely to any application program needing to move or copy data via a 3PCE.

An embodiment of the invention is, in part, a recognition that robust generation of third party copy commands, such as SCSI EXTENDED COPY commands, requires a complicated piece of software that can accommodate a great many combinations of data source devices, third party copy engines (3PCEs) and destination storage devices.

An embodiment of the invention is also, in part, a recognition that it is burdensome to require each application program, such as the application programs 104, 106 and 108 in background FIG. 1, to independently provide such robust third party copy command (e.g., SCSI EXTENDED COPY command) generation capability. Alternatively, the invention also is, in part, a recognition that limiting the numbers of source storage devices, 3PCEs and destination storage devices that are supported by an application program can significantly detract from the application program's competitiveness in the market.

An embodiment of the invention also is, in part, a recognition that an application program can invoke robust third party copy command (e.g., SCSI EXTENDED COPY command) capability without the need for it to independently provide complex command generation software if a liaison (to generate the command) is provided between the application program and the third party copy engine.

An embodiment of the invention also is, in part, a recognition that such a liaison need only receive a request for a third party copy command (e.g., SCSI EXTENDED COPY command) from an application program that identifies the 3PCE to be used, a destination device to receive the copied data, identification of the desired data that is to be copied and an identification of the source of the desired data. Accordingly, the invention also, in part, provides an interface protocol by which application programs can communicate such information (namely what is to be copied, by-whom, from-where and to-where) to the liaison.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed:

1. A first code arrangement on a computer-readable medium, execution of which causes a processor to generate a second code arrangement representing a third party copy command and corresponding parameters thereof, the arrangement comprising:
a calling portion in response to which said processor is operable to begin the second-code-arrangement generation process; and
at least one data entity portion upon which said generation process operates, wherein each data entity portion identifies a third party copy device (“3PCE”) to carry out the copy process, a destination device to receive the copied data, desired data that is to be copied and a source of said desired data.

2. The computer-readable first code arrangement of claim 1, wherein each said data entity portion is a data structure in the form of an array that includes:
a 3PCE identifier that identifies a 3PCE;
a destination device identifier to identify said destination device; and
a source array to identify desired data to be copied and at least one source from which to copy corresponding desired data.

3. The computer-readable first code arrangement of claim 1, wherein said at least one data entity portion is a data structure in the form of an array that is itself an element in an array of said data entity arrays.

4. The computer-readable first code arrangement of claim 1, further comprising:
at least one portion of in-line data that provides context so as to enhance a recovery operation to which said data entity portion is relevant.

5. The computer-readable first code arrangement of claim 1, wherein said data entity portion identifies only a single destination to receive said copied data.

6. The computer-readable first code arrangement of claim 1, wherein said desired data is formed of at least two different parts such that said data entity portion correspondingly identifies at least two sources of said different portions, respectively.

7. The computer-readable first code arrangement of claim 1, wherein said copy command code is the EXTENDED COPY command defined by the Small Computer Systems Interface (“SCSI”) standard.

8. The computer-readable first code arrangement of claim 1, where said first code arrangement is an alphanumeric text string in source code.

9. The computer-readable first code arrangement of claim 1, wherein said first code arrangement is block within machine-executable code.

10. A liaison system interposed between an application program running on a host and a third party copy engine (“3PCE”) external to said host, said application program needing to copy desired data from a source device external to said host to a destination device external to said host via said 3PCE, the liaison system comprising:
an application program interface (“API”) to receive the following first code arrangement from said application program:
a calling portion; and
at least one data entity portion that identifies said 3PCE, said destination, said desired data and said source; and
a copy command generator to generate a second code arrangement string representing a copy command and corresponding parameters thereof that will cause said 3PCE to copy said desired data from said source to said destination;
wherein said generator begins operation in response to said calling portion; and
wherein said generator is operable to generate said second code arrangement based upon said data entity portion.

11. The liaison system of claim 10, wherein said second code arrangement represents the EXTENDED COPY command defined by the Small Computer Systems Interface (“SCSI”) standard.

12. The liaison system of claim 10, wherein said generator is operable to query said 3PCE to confirm that said 3PCE is of a type supported by said generator before said generator generates said second code arrangement.

13. The liaison system of claim 10, wherein said generator is operable to query said 3PCE to obtain particular operational parameters supported by said 3PCE for a copy operation.

14. The liaison system of claim 10, wherein said generator is operable to verify that said particular operational parameters received from said 3PCE are each supported by said generator before said generator generates said second code arrangement.

15. The liaison system of claim 14, wherein, if said generator supports fewer than all of said particular operation parameters, said generator is operable to communicate with said 3PCE to confirm that said 3PCE can tolerate receiving a copy command for which the unsupported ones of said particular operational parameters are not present before said generator generates said second code arrangement.

16. The liaison system of claim 10, wherein if a size of said desired data is greater than said 3PCE can accommodate via execution of a single a copy command, then said generator is operable to generate a plurality of said second code arrangements, wherein each one of said plurality copies less than all of said desired data but together said plurality copies all of said desired data.

17. The liaison system of claim 10, wherein said host, said API and said generator are each processes running on a server, and
wherein said server includes at least one non-volatile memory, at least one processor, and at least one random access memory (RAM) arranged on at least one of: a motherboard where said at least one processor is also located; and on at least one circuit card separate from said mother board.

18. A method of interfacing between application program running on a host and a third party copy engine (“3PCE”) external to said host, said application program needing to copy desired data from a source device external to said host to a destination device external to said host via said 3PCE, the method comprising:
receiving a first code arrangement from said application program, said first code arrangement including:
a calling portion; and
at least one data entity portion that identifies said 3PCE, said destination, said desired data and said source;
initiating, in response to said calling portion, a process to generate a second code arrangement representing a copy command and corresponding parameters thereof that will cause said 3PCE to copy said desired data from said source to said destination; and
forming, once said process is begun, said second code arrangement based upon said data entity portion.

19. The method of claim 18, wherein said second code arrangement represents the EXTENDED COPY command defined by the Small Computer Systems Interface (“SCSI”) standard.

20. The method of claim 18, further comprising:
querying, before said second code arrangement is formed, said 3PCE to confirm that said 3PCE is of a type supported by said method.

21. The method of claim 18, querying said 3PCE to obtain particular operational parameters supported by said 3PCE for a copy operation.

22. The method of claim 21, further comprising:
verifying, before said second code arrangement is formed, that said particular operational parameters received from said 3PCE are each supported by said method.

23. The method of claim 18, further comprising:
communicating with said 3PCE, if said generator supports fewer than all of said particular operation parameters, to confirm that said 3PCE can tolerate receiving a copy command for which the unsupported ones of said particular operational parameters are not present before said second code arrangement is formed.

24. The method of claim 18, further comprising:
repeating the step of forming, if a size of said desired data is greater than said 3PCE can accommodate via execution of a single a copy command, so as to form a plurality of said second code arrangements, wherein each one of said plurality copies less than all of said desired data but together said plurality copies all of said desired data.

25. A computer-readable medium having code portions embodied thereon that, when read by a first processor, cause a second processor to perform the method of claim 1.

26. The computer-readable medium of claim 25, wherein said first processor and said second processor are the same.

27. A liaison system interposed between an application program running on a host and a third party copy engine (“3PCE”) external to said host, said application program needing to copy desired data from a source device external to said host to a destination device external to said host via said 3PCE, the liaison system comprising:
an application program interface (“API”) to receive the following first code arrangement from said application program:
a calling portion; and
at least one data entity portion that identifies said 3PCE, said destination, said desired data and said source; and
a copy command generator to generate a second code arrangement representing the EXTENDED COPY command defined by the Small Computer Systems Interface (“SCSI”) standard and corresponding parameters thereof that will cause said 3PCE to copy said desired data from said source to said destination;
wherein said generator begins operation in response to said calling portion; and
wherein said generator is operable to generate said second code arrangement based upon said data entity portion;
wherein said generator is operable to query said 3PCE a first time to confirm that said 3PCE is of a type supported by said generator before said generator generates said second code arrangement;
wherein, if said 3PCE is supported, then said generator is operable to query said 3PCE a second time to obtain particular operational parameters supported by said 3PCE for a copy operation;
wherein said generator is operable to verify that said particular operational parameters received from said 3PCE are each supported by said generator before said generator generates said second code arrangement;
wherein, if said generator supports fewer than all of said particular operation parameters, then said generator is operable to communicate with said 3PCE to confirm that said 3PCE can tolerate receiving a copy command for which the unsupported ones of said particular operational parameters are not present before said generator generates said second code arrangement; and
wherein if a size of said desired data is greater than said 3PCE can accommodate via execution of a single a copy command, then said generator is operable to generate a plurality of said second code arrangements, wherein each one of said plurality copies less than all of said desired data but together said plurality copies all of said desired data.

28. A method of interfacing between application program running on a host and a third party copy engine (“3PCE”) external to said host, said application program needing to copy desired data from a source device external to said host to a destination device external to said host via said 3PCE, the method comprising:
receiving a first code arrangement from said application program, said first code arrangement including:
a calling portion; and
at least one data entity portion that identifies said 3PCE, said destination, said desired data and said source; and
initiating, in response to said calling portion, a process to generate a second code arrangement representing the EXTENDED COPY command defined by the Small Computer Systems Interface (“SCSI”) standard and corresponding parameters thereof that will cause said 3PCE to copy said desired data from said source to said destination;
forming, once said process is begun, said second code arrangement based upon said data entity portion;
querying, before said second code arrangement is formed, said 3PCE to confirm that said 3PCE is of a type supported by said method;
querying said 3PCE to obtain particular operational parameters supported by said 3PCE for a copy operation;
verifying, before said second code arrangement is formed, that said particular operational parameters received from said 3PCE are each supported by said method;
communicating with said 3PCE, if said generator supports fewer than all of said particular operation parameters, to confirm that said 3PCE can tolerate receiving a copy command for which the unsupported ones of said particular operational parameters are not present before said second code arrangement is formed; and
repeating the step of forming, if a size of said desired data is greater than said 3PCE can accommodate via execution of a single a copy command, so as to form a plurality of said second code arrangements, wherein each one of said plurality copies less than all of said desired data but together said plurality copies all of said desired data.
